(19) United States
(12) Patent Application Publication
(10) Pub. No.: US 2023/0241696 A1
(43) Pub. Date: Aug. 3, 2023

(54) CUTTING TOOL

(71) Applicant: Nanjing Chervon Industry Co., Ltd., Nanjing (CN)

(72) Inventors: Rong Wang, Nanjing (CN); Shaojun Wang, Nanjing (CN)

(21) Appl. No.: 18/299,527

(22) Filed: Apr. 12, 2023

Related U.S. Application Data
(63) Continuation of application No. PCT/CN2021/139118, filed on Dec. 17, 2021.

(30) Foreign Application Priority Data
Dec. 25, 2020 (CN) 202011567840.8

(51) Int. Cl. B23D 59/02; B23D 45/16; B23D 47/12; B23D 59/00

(52) U.S. Cl. CPC B23D 59/02; B23D 45/16; B23D 47/12; B23D 59/001

(57) ABSTRACT

A cutting tool includes an electric motor supported by a housing, an accessory mounting portion including an output member connected to a saw blade, a transmission mechanism connecting the electric motor to the output member, a base plate disposed at the bottom of the housing and having a mounting hole for the saw blade to pass through, a battery pack interface configured to be detachably connected to a battery pack, a liquid storage system including a liquid storage device configured to store a liquid and detachably mounted on the housing, and a system control member disposed on a liquid flow path of the liquid storage system and used for controlling the flow state of the liquid in the liquid storage device. The electric motor is a brushless motor, and a rotational speed of the electric motor is not lower than 7000 revolutions per minute.

### RELATED APPLICATION INFORMATION

This application is a continuation of International Application Number PCT/CN2021/139118, filed on Dec. 17, 2021, through which this application also claims the benefit under 35 U.S.C. § 119(a) of Chinese Patent Application No. 202011567840.8, filed on Dec. 25, 2020, which applications are incorporated herein by reference in their entirety.

### BACKGROUND

A cutting tool is used for cutting a workpiece and provided with a base plate for assisting with a cutting action. Cutting tools in the related art are relatively bulky, and the performance of electric motors is not conducive to long-time operation.

### SUMMARY

A cutting tool is provided. The cutting tool includes: a housing; an electric motor supported by the housing; an accessory mounting portion including an output member connected to a saw blade; a transmission mechanism connecting the electric motor to the output member; and a base plate disposed at the bottom of the housing and having a mounting hole for the saw blade to pass through. The cutting tool further includes a liquid storage system including a liquid storage device configured to store a liquid and detachably mounted on the housing. The electric motor is a brushless motor, where a rotational speed of the electric motor is not lower than 7000 revolutions per minute.

A cutting tool includes: a housing; an electric motor supported by the housing; an accessory mounting portion including an output member connected to a saw blade; a transmission mechanism connecting the electric motor to the output member; and a base plate disposed at the bottom of the housing and having a mounting hole for the saw blade to pass through. The cutting tool further includes: a power interface configured to be detachably connected to a power supply device; and a liquid storage system including a liquid storage device configured to store a liquid and detachably mounted on the housing.

A cutting tool includes: a housing; an electric motor supported by the housing; an accessory mounting portion including an output member connected to a saw blade; a transmission mechanism connecting the electric motor to the output member; and a base plate disposed at the bottom of the housing and having a mounting hole for the saw blade to pass through. The cutting tool further includes: a liquid storage system including a liquid storage device configured to store a liquid and detachably mounted on the housing; and a system control member disposed on a liquid flow path of the liquid storage system and used for controlling the flow state of the liquid in the liquid storage device.

A cutting tool includes: a housing; an electric motor disposed in the housing to provide a driving force for the cutting tool; an operation element capable of being triggered by a user to have multiple operation states; a liquid storage system including a liquid storage device mounted on the housing and a guide guiding a liquid flow direction; a system control member disposed on a liquid flow path of the liquid storage system and used for controlling the flow state of a liquid in the liquid storage device; and a controller electrically connected to at least the operation element and the system control member. The controller is configured to: acquire control signals outputted by the operation element in different operation states; when a first control signal is acquired, control the system control member to be opened so that the liquid storage system is started; and when a second control signal is acquired, control the electric motor to rotate.

A cutting tool includes: a housing; an electric motor disposed in the housing to provide a driving force for the cutting tool; a liquid storage system including a liquid storage device mounted on the housing and a guide guiding a liquid flow direction; a system control member disposed on a liquid flow path of the liquid storage system and used for controlling the flow state of a liquid in the liquid storage device; and an operation element capable of being triggered by a user to have multiple operation states. When the operation element is in a first operation state, the system control member is capable of being triggered to be opened so that the liquid storage system is started; and when the operation element is in a second operation state, the electric motor is capable of being triggered to rotate.

A cutting tool includes: a housing; an electric motor supported by the housing; an accessory mounting portion including an output member connected to a saw blade; a transmission mechanism connecting the electric motor to the output member; and a base plate disposed at the bottom of the housing and having a mounting hole for the saw blade to pass through. The housing includes a shield; and the shield is disposed on the upper side of the base plate.

### BRIEF DESCRIPTION OF DRAWINGS

FIG. 1 is a perspective view of a cutting tool in an example of the present application;

FIG. 2 is a perspective view of the cutting tool in FIG. 1 from another angle;

FIG. 3 is a perspective view of the cutting tool in FIG. 1 from another angle;

FIG. 4 is a schematic view of internal structures of the cutting tool in FIG. 1;

FIG. 5A is a sectional view of part of structures of the cutting tool in FIG. 1;

FIG. 5B is a partial enlarged view of part D in FIG. 5A;

FIG. 6 is a schematic view showing an air inlet and an air outlet of the cutting tool in FIG. 1;

FIG. 7 is a schematic view of internal structures of the cutting tool in FIG. 1;

FIG. 8 is a schematic view of a water supply system and a saw blade of the cutting tool in FIG. 1;

FIG. 9 is a schematic view of a water supply system of the cutting tool in FIG. 1;

FIG. 10 is a schematic view of a water container and a connection device of the cutting tool in FIG. 1;

FIG. 11 is an enlarged schematic view of a connection device of the cutting tool in FIG. 1;

FIG. 12 is a graph showing the relationship between the water flow velocity of a water container of the cutting tool in FIG. 1 and time;

FIG. 13 is a schematic view of a base plate of the cutting tool in FIG. 1;

FIG. 14 is a schematic view showing the angle at which a mudguard of the cutting tool in FIG. 1 is inclined;

FIG. 15 is a schematic view showing the height of a mudguard of the cutting tool in FIG. 1;

FIG. 16 is a schematic view showing the size of the included angle between an end of a water delivery pipe and a saw blade of the cutting tool in FIG. 1;

FIG. 17 is a schematic view of a waterproof portion of the cutting tool in FIG. 1;

FIG. 18 is a schematic view of a base plate of a cutting tool in this example;

FIG. 19 is a schematic diagram of a control system of the cutting tool in FIG. 1;

FIG. 20 is a schematic diagram of a control system of the cutting tool in FIG. 1;

FIG. 21 is a schematic diagram of a control system of the cutting tool in FIG. 1;

FIG. 22 is a schematic diagram of a control system of the cutting tool in FIG. 1;

FIG. 23 is a schematic diagram of a control system of the cutting tool in FIG. 1;

FIG. 24 is a flowchart of a method for controlling the cutting tool in FIG. 1;

FIG. 25 is a perspective view of a cutting tool in an example of the present application;

FIG. 26 is a perspective view of the cutting tool in FIG. 25 from another angle;

FIG. 27 is a perspective view of part of structures of the cutting tool in FIG. 25 from one angle;

FIG. 28 is a perspective view of part of structures of the cutting tool in FIG. 25 from another angle;

FIG. 29 is a schematic view of part of structures of the cutting tool in FIG. 25; and

FIG. 30 is a perspective view of the cutting tool in FIG. 25 from another angle.

### DETAILED DESCRIPTION

The present application is described below in detail in conjunction with drawings and examples.

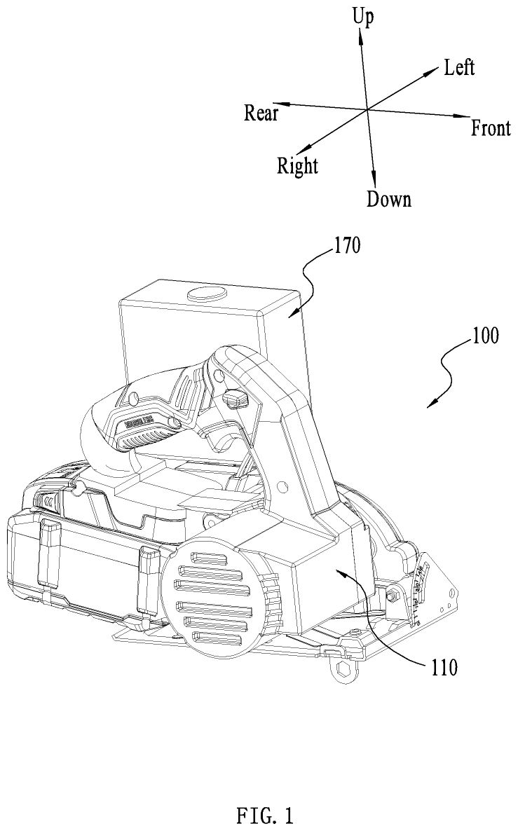

In an example of the present application, referring to FIGS. 1 to 3, a cutting tool 100 is provided. For example, the cutting tool 100 may be a marble cutter usable for cutting a workpiece such as stone. The cutting tool 100 drives a saw blade 131 to rotate to grind and cut the stone. The cutting tool 100 includes a housing 110, an electric motor 120, an accessory mounting portion 130, and a transmission mechanism 140. The electric motor 120 is supported by the housing 110. The accessory mounting portion 130 includes an output member 1311 connected to the saw blade 131. The transmission mechanism 140 connects the output member to the electric motor 120. The cutting tool 100 further includes a power interface 150 configured to be connected to a power supply. In an example, the power supply may be alternating current mains. In an example, the power supply is a direct current power supply, such as a battery pack, and the power interface 150 may also be referred to as a battery pack interface 150. The battery pack interface 150 is detachably connected to a battery pack 200. The battery pack 200 can power the electric motor 120, and the electric rotor 120 rotates and drives, through the transmission mechanism 140, the output member to rotate so that the saw blade 131 can grind and cut the workpiece. For example, metal particles are disposed on the cutting surface of the saw blade 131, and the workpiece is cut by the metal particles.

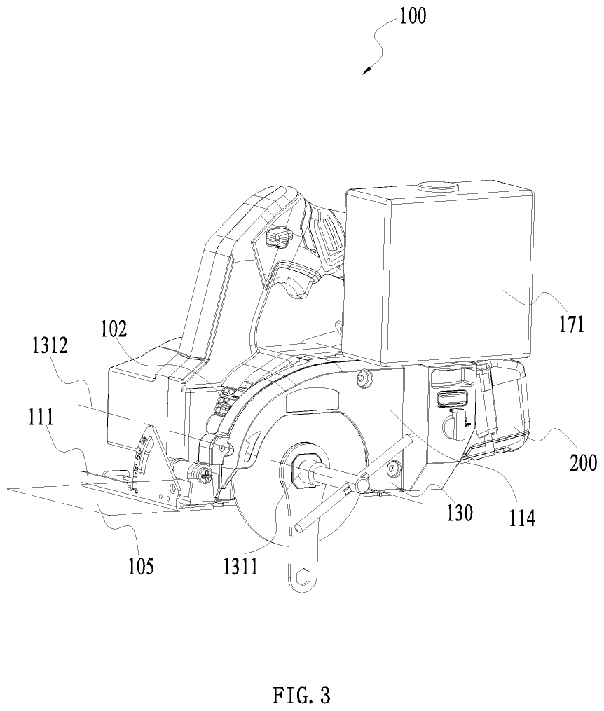

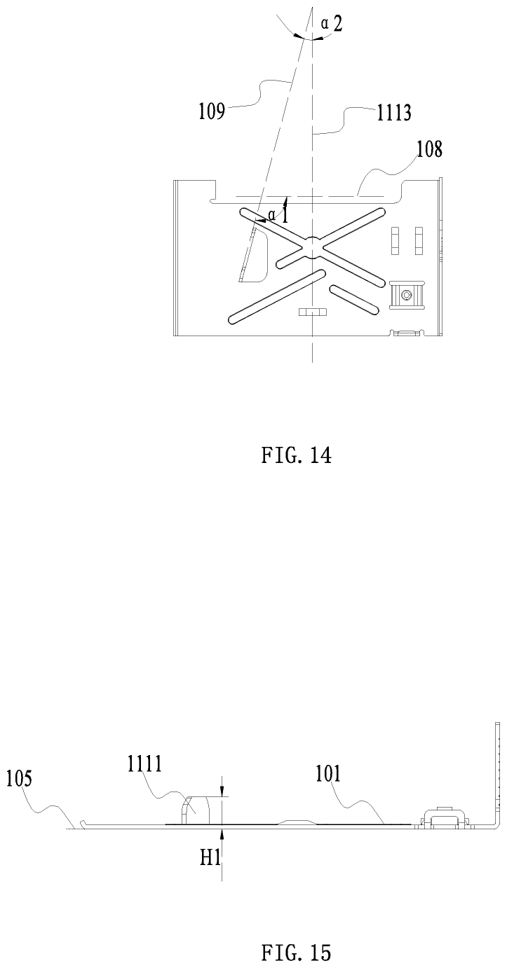

Referring to FIGS. 3 and 14, the cutting tool 100 further includes a base plate 111, where the base plate 111 extends along a first plane 105 and is disposed at the bottom of the housing 110. The base plate 111 has a mounting hole 1116 for the saw blade 131 to pass through. The base plate 111 can assist a user in cutting. The saw blade 131 passes through the mounting hole 1116 and is rotatable relative to the base plate 111. The mounting hole 1116 may be a closed or semi-closed slot. A sawing indicator is further disposed at the front end of the base plate 111. The sawing indicator can indicate a first straight line 108 formed by a vertical projection of the saw blade 131 toward the base plate 111, and the cutting tool 100 can cut along the direction of the first straight line 108. The vertical projection of the saw blade 131 toward the base plate 111 refers to a projection of the saw blade 131 in a vertical direction when the base plate 111 is horizontally placed and the saw blade 131 is perpendicular to the base plate 111.

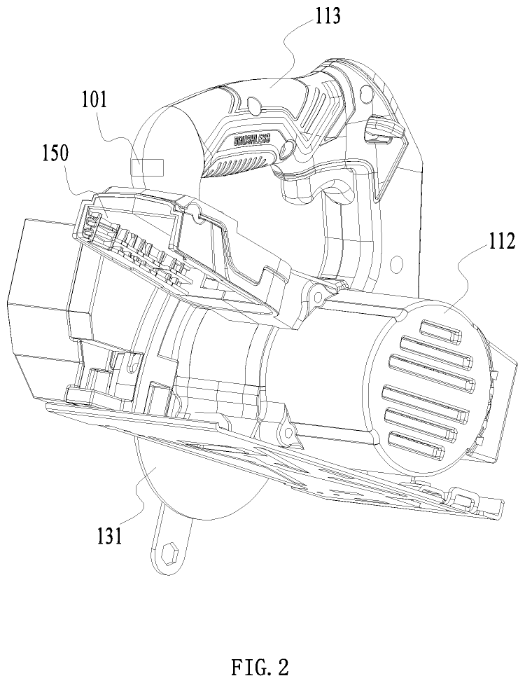

Referring to FIGS. 2 and 3, the housing 110 forms an electric motor accommodation portion 112 and a grip 113, where the electric motor accommodation portion 112 is used for placing the electric motor 120, and the user holds the grip 113 to operate the cutting tool 100. The battery pack interface 150 is disposed at the rear end of the electric motor accommodation portion 112. The accessory mounting portion 130 is disposed at a side end of the electric motor accommodation portion 112. The rear end of the electric motor accommodation portion 112 refers to a direction opposite to the front end of the cutting tool 100 at which the sawing indicator is located. Since the saw blade 131 has a relatively small size, the battery pack interface 150 may be disposed at the rear end of the electric motor accommodation portion 112. After the battery pack 200 is mounted to the battery pack interface 150, the battery pack 200 is disposed at the rear end of the electric motor accommodation portion 112, and a projection of the saw blade 131 along the direction of the first straight line 108 partially overlaps a projection of the battery pack 200 along the direction of the first straight line 108 so that the whole cutting tool 100 has a compact structure.

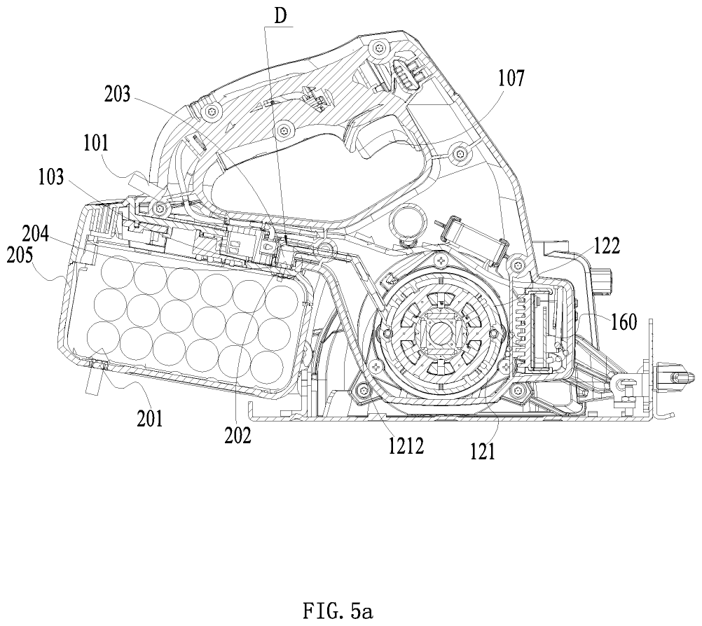

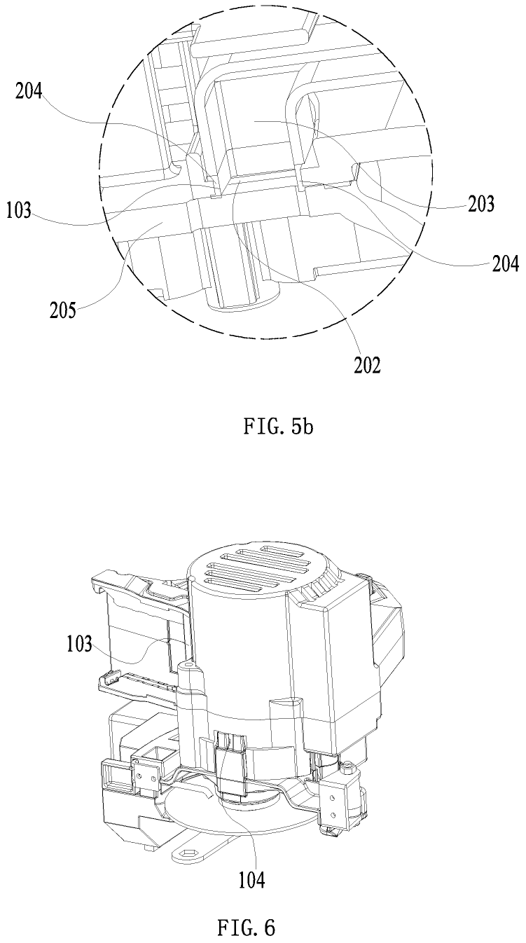

Referring to FIG. 5, the cutting tool 100 further includes a control board 160, where the control board 160 can control the running of the electric motor 120. In an implementation, the battery pack 200 is disposed at the rear end of the electric motor accommodation portion 112, the control board 160 is disposed at the front end of the electric motor accommodation portion 112, and the control board 160 is located in the housing 110. In an exemplary implementation, the control board 160 may be disposed at the upper end, the lower end, or the rear end of the electric motor accommodation portion 112. The cutting tool 100 further includes a trigger 107. When the user presses the trigger 107, the control board 160 controls the electric motor 120 to be turned on, and the cutting tool 100 starts and drives the saw blade 131 to rotate.

Referring to FIGS. 2, 3, and 5, the cutting tool 100 includes a first air inlet 101 and a first air outlet 102, where the first air inlet 101 is disposed at the rear end of the housing 110, the first air outlet 102 is disposed at the front end of the electric motor accommodation portion 112, and part of an airflow can enter the housing 110 from the first air inlet 101 and flow through the battery pack interface 150. The battery pack 200 is mounted to the battery pack interface 150. When the cutting tool 100 is powered, a temperature rise at a pole piece of the battery pack 200 is relatively high. The heat of the battery pack 200 and the heat of the pole piece of the battery pack 200 can be effectively dissipated by the airflow entering the housing 110 from the first air inlet 101, thereby preventing the battery pack 200 from overheating.

Referring to FIGS. 5 and 6, hollow arrows in FIG. 5 show directions in which heat dissipation airflows flow. The cutting tool 100 includes a second air inlet 103 and a second air outlet 104, where the second air inlet 103 is disposed at the battery pack interface 150, and the second air outlet 104 is disposed at the lower end of the electric motor accommodation portion 112. The battery pack 200 includes a battery pack housing 205 and battery cells disposed in the battery pack housing 205, where the battery pack housing 205 includes a first vent 201 and a second vent 202, and the second vent 202 communicates with the second air inlet 103 when the battery pack 200 is mounted to the battery pack interface 150. The cutting tool further includes a connection channel 203, where one end of the connection channel 203 is connected to the second vent 202 or the second air inlet 103, and the other end of the connection channel 203 is connected to a fifth vent 1212 on an electric motor housing 121. Thus, part of the airflow can enter the battery pack housing 205 from the first vent 201, dissipate the heat of the battery cells, flow to the second air inlet 103 through the second vent 202, and flow into the electric motor housing 121 along the connection channel 203. That is to say, the airflow after dissipating the heat of the battery pack 200 can be reused for dissipating the heat of the electric motor based on the connection channel 203. The airflow entering the electric motor 120 from the first air inlet 101 and the second air inlet 103 can be discharged out of the housing through the first air outlet 102 and the second air outlet 104. The first air outlet 102 is disposed at the front end of the electric motor accommodation portion 112, and part of the airflow is discharged from the front end of the electric motor accommodation portion 112 so that the front end of the housing 110 can be waterproof and slurry at the front end of the housing 110 can be blown away. The second air outlet 104 is disposed on the lower side of the electric motor accommodation portion 112 so that part of the airflow can be discharged downward from the lower side of the electric motor accommodation portion 112, and the airflow can flow to the base plate 111, thereby blowing away a cooling liquid, dust, and slurry of the base plate 111.

The cutting tool 100 further includes a sealing member 204. The sealing member 204 shown in FIGS. 5A and 5B is disposed between the second vent 202 and the second air inlet 103 so that a gas flowing out of the second vent 202 can be prevented from leaking into the tool, and the utilization rate can be ensured with which a gas in the battery pack is reused for dissipating the heat of the electric motor. The sealing member 204 may be in contact with the peripheral side of an opening at an end of the connection channel 203 so as to prevent the gas from leaking when the gas flows to the connection channel 203 through the second vent 202 and the second air inlet 103.

In an example, the sealing member 204 may be disposed on the peripheral side of the second air inlet 103 or the peripheral side of the second vent 202, or disposed at the upper end of the second vent 202. When the battery pack 200 is mounted to the battery pack interface 150, the sealing member 204 can avoid the case where the airflow is discharged from the gap between the second air inlet 103 and the second vent 202, thereby reducing the efficiency of heat dissipation in the housing 110. In an example, the sealing member 204 and the opening of the second air inlet 103 may have the same shape. In an example shown, the sealing member 204 is a rectangular ring. In an example, the sealing member 204 is an elastic member, for example, an elastic rubber ring. Thus, when the battery pack 200 is mounted to the battery pack interface 150, the sealing member can adapt to the mating of the second air inlet 103 with the second vent 202 well to seal the connection between the second air inlet 103 and the second vent 202. In an example, a sealing member may also be disposed on the outer side of the first vent 201 on the battery pack housing 205 to prevent a gap between the battery pack housing 205 and the housing 110 of the tool from affecting a ventilation effect.

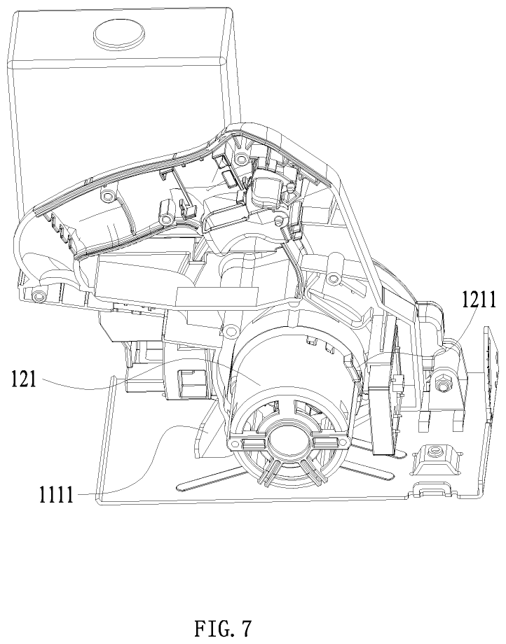

Referring to FIGS. 5A and 7, the electric motor 120 includes the electric motor housing 121 and a fan 122 disposed in the electric motor housing 121. The electric motor 120 further includes a rotor and a stator, and the rotor is rotatable relative to the stator. The fan 122 is connected to the electric motor 120 and rotates during the running of the electric motor 120 to generate the airflow for dissipating the heat of the housing 110. The cutting tool 100 further includes a first heat dissipation channel causing the electric motor housing 121 and the second air inlet 103 to communicate with each other so as to guide the airflow to pass through the first heat dissipation channel and flow into the electric motor housing 121. Thus, heat dissipation in the electric motor 120 is enhanced.

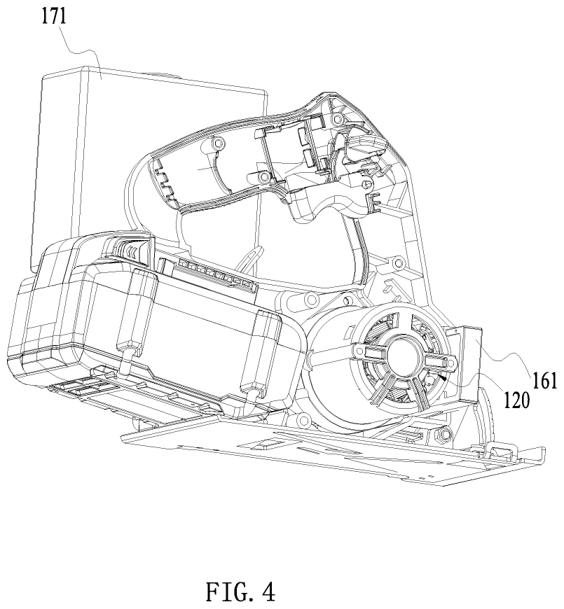

Referring to FIG. 4, the housing 110 forms a control chamber 161 accommodating the control board 160. The control chamber 161 may be inwardly extending ribs in the housing 110, and the control chamber 161 forms an accommodation cavity accommodating the control board 160. The electric motor housing 121 is provided with a third vent 1211, where the third vent 1211 opens toward the control chamber 161 and is configured to guide part of the airflow to enter the electric motor housing 121 from the control chamber 161 through the third vent 1211. For example, the electric motor housing 121 is provided with a fourth vent. Part of the airflow flows near a capacitor plate and enters the electric motor housing 121 through the fourth vent to enhance the heat dissipation of the capacitor plate.

The rated voltage of the battery pack 200 is higher than or equal to 10 V and lower than or equal to 26 V. For example, the rated voltage of the battery pack 200 is 10 V, 12 V, 15 V, 18 V, 20 V, 24 V, 26 V, or the like. In an example, the electric motor 120 is a brushless motor, a rotational speed of the electric motor 120 is not lower than 7000 revolutions per minute when the cutting tool is in a working state, and when the electric motor 120 is unloaded, the electric motor 120 can output torque of greater than or equal to 0.8 N·m and less than or equal to 1.2 N·m. Thus, the cutting efficiency of the cutting tool 100 can be effectively improved, and the overall size of the cutting tool 100 can be relatively small so that the cutting tool 100 is convenient to carry and use. The rotational speed of the motor 120 when the cutting tool 100 enters the working state refers to the rotational speed when the motor 120 enters the working state after completing a starting process.

Referring to FIGS. 1 and 3, the cutting tool 100 further includes a liquid storage system 170, where the liquid storage system 170 includes a liquid storage device 171 configured to store a liquid and detachably mounted on the housing 110. In an example, one type of cooling liquid or non-cooling liquid or two or more types of liquids may be stored in the liquid storage device 171. When multiple types of liquids are stored, a partition needs to be added to a structure in the liquid storage device 171, or another configuration is performed on a structure in the liquid storage device 171. For example, the liquid storage device 171 is a water container and can store cooling liquid water. The battery pack 200 and the electric motor 120 are disposed on the same side of the housing 110, and the liquid storage device 171 can be connected to the other side of the housing 110. The grip 113 is disposed above the electric motor accommodation portion 112 and the battery pack interface 150.

The battery pack interface 150 may extend along the direction of the first straight line 108 so that the battery pack 200 can be inserted into battery pack interface 150 along the direction of the first straight line 108 to be connected to the housing 110. Thus, the battery pack 200 can balance the weight of the electric motor 120 and the weight of the saw blade 131 so that when the user holds the grip 113, a projection of the center of gravity of the cutting tool 100 along a direction perpendicular to the first plane 105 overlaps a projection of the grip 113 along the direction perpendicular to the first plane 105 or a projection of the accessory mounting portion 130 along the direction perpendicular to the first plane 105, or a projection of the center of gravity of the cutting tool 100 along a direction perpendicular to the first plane 105 is between a projection of the grip 113 in the direction perpendicular to the first plane 105 and a projection of the accessory mounting portion 130 in the direction perpendicular to the first plane 105. For example, the battery pack interface 150 extends along a direction perpendicular to the first straight line 108 and parallel to the first plane 105 so that the battery pack 200 can be inserted into the battery pack interface 150 in the direction perpendicular to the first straight line 108 and parallel to the first plane 105 to be connected to the housing 110. Thus, the position of the center of gravity of the whole cutting tool 100 can be adjusted, thereby reducing the burden on the user when operating the cutting tool 100.

In an example, when the liquid storage device 171 is not mounted on the cutting tool 100, the projection of the center of gravity of the cutting tool 100 along the direction perpendicular to the first plane 105 is on the base plate 111, that is, an orthographic projection of the center of gravity of the cutting tool 100 is on the base plate 111. The whole cutting tool can have better balance, and the user saves more effort when holding and using the cutting tool 100. In an example, when the liquid storage device 171 is not mounted on the cutting tool 100, the projection of the center of gravity of the cutting tool 100 along the direction perpendicular to the first plane 105 overlaps the projection of the grip 113 along the direction perpendicular to the first plane 105 or the projection of the accessory mounting portion 130 along the direction perpendicular to the first plane 105, or the projection of the center of gravity of the cutting tool 100 along the direction perpendicular to the first plane 105 is between the projection of the grip 113 in the direction perpendicular to the first plane 105 and the projection of the accessory mounting portion 130 in the direction perpendicular to the first plane 105. The preceding projection refers to an orthographic projection.

The base plate 111 has a first position for causing the cutting tool 100 to be at the maximum cutting depth. When the base plate 111 is at the first position, the distance from the first plane 105 to the lowest point of the saw blade 131 is greater than or equal to 20 mm and less than or equal to 35 mm. The distance from the first plane 105 to the lowest point of the saw blade 131 is the cutting depth of the cutting tool 100. For example, the distance is 20 mm, 22 mm, 24 mm, 26 mm, 29 mm, 32 mm, or 35 mm. Thus, the cutting tool 100 can have a relatively small cutting depth and is more suitable for the working condition where the stone is cut, thereby effectively improving cutting accuracy.

Referring to FIG. 3, the housing 110 further includes a shield 114 disposed on the peripheral side of the saw blade 131. In the direction perpendicular to the first plane 105, the top of the shield 114 is close to the base plate 111 relative to the top of the grip 113, and the height difference between the top of the grip 113 and the top of the shield 114 in the direction perpendicular to the first plane 105 is set to be greater than or equal to 100 mm or 90 mm. The grip 113 is disposed on the upper portion of the cutting tool 100, and the grip 113 includes a handle for the user to hold. In a front and rear direction, an orthographic projection of the handle on the first plane 105 is between a projection of the battery pack 200 on the first plane 105 and a projection of the electric motor 120 on the first plane 105. In the front and rear direction, the handle is disposed behind the output member 1311 so that it is convenient for the user to push the cutting tool 100 and the component force in the direction in which the user pushes the cutting tool 100 is reduced. In a direction extending rearward, the handle tends to extend downward so that it is convenient for the user to push the cutting tool 100 by operating the handle. For example, the height difference between the top of the grip 113 and the top of the shield 114 in this direction is 120 mm. The shield 114 of the cutting tool 100 is provided only with a fixed shield and not with a movable shield.

For example, the liquid storage device 171 is disposed above the accessory mounting portion 130 and located on a side of the grip 113. The output member 1311 is rotatable about a first axis 1312. When the liquid storage device 171 is mounted on the housing 110, an orthographic projection of the liquid storage device 171 along the first axis on the first plane 105 is within an orthographic projection of the outer contour of the housing 110 on the first plane 105.

Referring to FIG. 3, the base plate 111 extends along the first plane 105, and in the direction perpendicular to the first plane 105, the top of the liquid storage device 171 is close to the base plate 111 relative to the top of the grip 113. For example, the height difference between the top of the grip 113 and the top of the liquid storage device 171 in this direction is set to be greater than or equal to 35 mm. The liquid storage device 171 can be prevented from blocking the field of view of the user on the sawing indicator when the cutting tool 100 is operated.

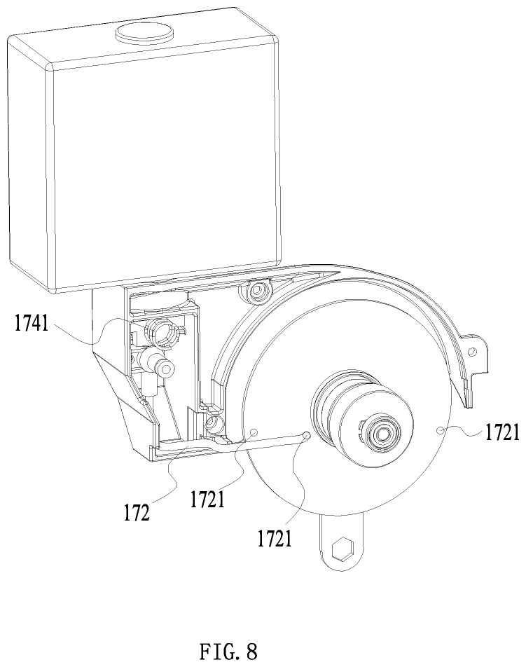

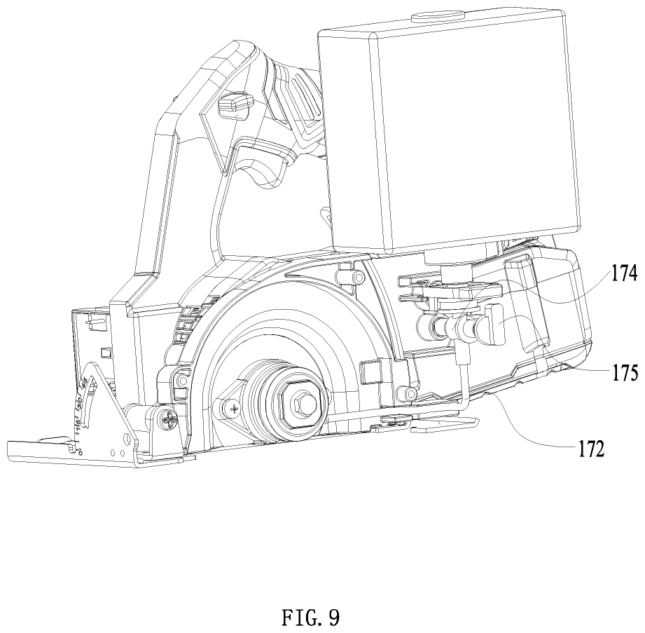

Referring to FIGS. 8 and 9, the liquid storage system 170 includes a guide 172, where the guide 172 is connected to the liquid storage device 171 and can guide a liquid in the liquid storage device 171 to flow to the base plate 111 and/or the saw blade 131. In an example, the guide 172 may be a water delivery pipe such as a flexible or rigid water pipe. It is to be noted that if the guide 172 is a flexible conduit, a conduit fixing member may be added to fix the conduit in the accessory mounting portion 130 to avoid the case where the saw blade 131 is in contact with guide ports 1721 of the guide 172 resulting in damage to the guide 172. For example, the liquid stored in the liquid storage device 171 may be water. In an example, the guide 172 has at least two guide ports 1721 configured to be toward the accessory mounting portion 130 and/or the housing 110. For example, the guide 172 is provided with two water pipes, and the guide ports 1721 are disposed on the accessory mounting portion 130, or the guide ports 1721 are disposed on the accessory mounting portion 130 and the housing 110. The saw blade 131 rotates around a rotation center, and the guide ports 1721 are configured to be toward the front and rear direction of the rotation center. For example, the guide ports 1721 are disposed at the foremost end of the saw blade 131 and the rearmost end of the saw blade 131, the saw blade 131 may be used for accelerating the liquid so that the liquid flows from the saw blade 131 to the base plate 111 to carry away the slurry on the base plate 111, and the amount of water supplied to the saw blade 131 can be ensured so that the liquid sufficiently cools the saw blade 131.

For example, referring to FIG. 8, three guide ports 1721 are provided, and in addition to being disposed at the foremost end of the saw blade 131 and the rearmost end of the saw blade 131, a guide port 1721 may also be disposed beside the guide 172 so that the heat of the central portion of the saw blade 131 can be sufficiently dissipated. The liquid storage system 170 further includes a system control member 174. The system control member 174 is disposed on a liquid flow path of the liquid storage system 170 and used for controlling the flow state of the liquid in the liquid storage device 171. For example, the system control member 174 is a water valve such as a three-way water valve, and the guide 172 is connected by the three-way water valve 174.

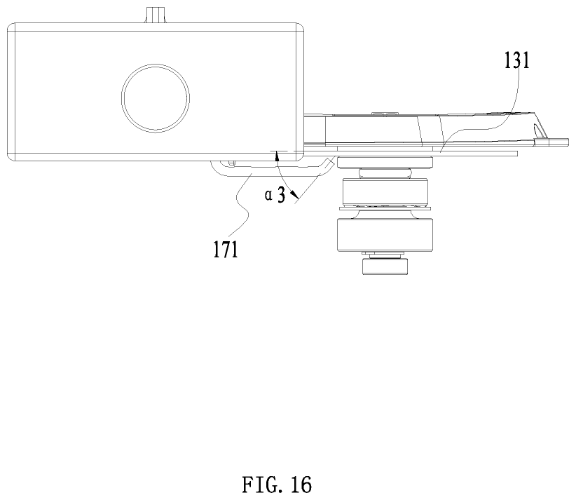

When mounted to the cutting tool 100, the saw blade 131 extends along a second plane. An end of the guide 172 is configured to be inclined relative to the second plane so that the liquid area formed by the cooling liquid spouting onto the saw blade 131 is increased and a heat dissipation effect is improved. For example, referring to FIG. 16, the end of the guide 172 is configured to form an included angle α3 with the second plane, where the included angle α3 is greater than or equal to 10 degrees and less than or equal to 60 degrees. Thus, the liquid spouting from the guide 172 can be prevented from deviating from the saw blade 131, and the liquid area formed by the cooling liquid spouting onto the saw blade 131 is increased.

For example, the liquid storage system 170 includes a water pump configured to be connected to the guide 172. When the user cuts a wall using the cutting tool 100, the first plane 105 is perpendicular or approximately perpendicular to the ground so that the liquid in the liquid storage device 171 cannot flow sufficiently to the guide port 1721. In this case, the water pump can deliver the liquid, thereby assisting with the operation of the cutting tool 100. For example, the cutting tool 100 further includes an inertial measurement unit configured to detect a relative attitude of the marble cutter, and when the included angle between the first plane 105 and the ground is greater than a preset value, the water pump is controlled by the controller to run, for example, the water pump is controlled by the user to be turned on.

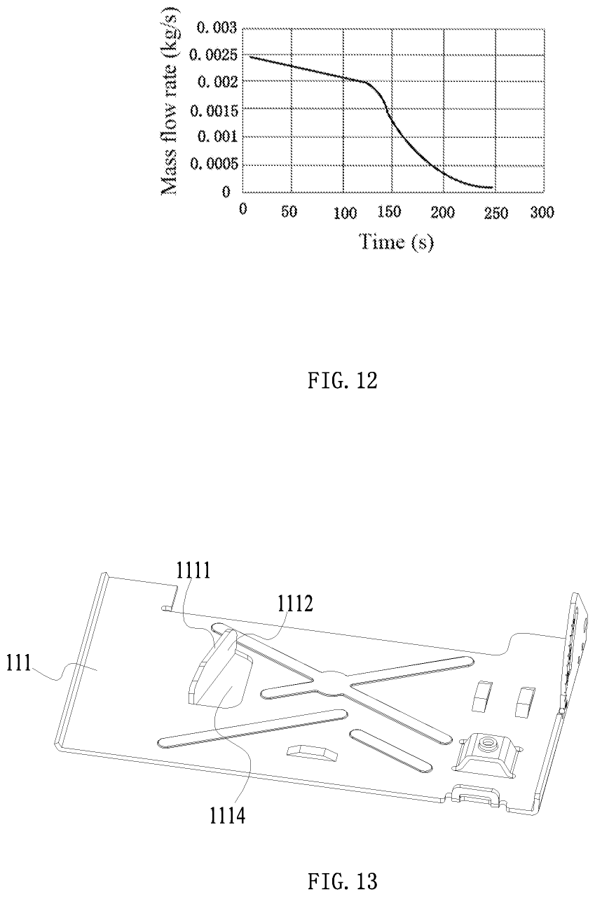

The liquid storage device 171 includes a liquid outlet. The guide 172 is connected to the liquid outlet, and the diameter of the liquid outlet is greater than or equal to 1 mm and less than or equal to 3 mm, for example, the diameter of the liquid outlet is 1 mm, 2 mm, or 3 mm. The liquid flow rate of the liquid outlet is higher than or equal to 0 g/s and lower than or equal to 2 g/s. Thus, the heat dissipation of the cutting tool 100 provided in this example is ensured, and the liquid in the liquid storage device 171 is prevented from being lost too quickly so that the user does not need to frequently add the liquid. Referring to FIG. 12, during the use of the cutting tool 100, as the liquid in the liquid storage device 171 flows out, a hydraulic pressure decreases, and water is used as an example and the water flow rate of the liquid outlet also decreases. When the liquid storage device 171 is filled with water, the water flow rate of the liquid outlet is 2.3 g/s to 2.5 g/s, and when only about 20% of the volume of the water in the liquid storage device 171 remains, the water flow rate of the liquid outlet is 0.4 g/s to 0.6 g/s.

Referring to FIG. 7 and FIGS. 13 to 15, the base plate 111 includes a mudguard 1111, where the mudguard 1111 protrudes upward relative to the first plane 105. The cutting tool 100 can cut along the direction of the first straight line 108, and the base plate 111 has the first position for causing the cutting tool to be at the maximum cutting depth. When the saw blade 131 is vertically disposed and the first plane 105 is in a horizontal plane, the base plate 111 is at the first position. The mudguard 1111 is disposed behind the base plate 111, which refers to that the mudguard 1111 is disposed rearward relative to the intermediate position of the base plate 111 to prevent the water and slurry on the base plate 111 from being splashed on the user. A discharge port 1114 is disposed in front of the mudguard 1111 so that the water and slurry are discharged directly from the discharge port 1114 in front of the mudguard 1111. A side surface of the mudguard 1111 forms a stop surface 1112 which can block the slurry. A projection of the stop surface 1112 toward the first plane 105 should be considered as the direction in which the whole mudguard 1111 extends. A projection of at least part of the stop surface 1112 along the direction perpendicular to the first plane 105 toward the first plane 105 forms an included angle α1 with the first straight line 108, where the included angle α1 is greater than or equal to 100 degrees and less than or equal to 135 degrees. Thus, the angle at which the stop surface 1112 is inclined is used for causing the slurry to be discharged toward one side of the stop surface 1112.

For example, a projection of the mudguard 1111 along the direction perpendicular to the first plane 105 toward the first plane 105 extends along a second straight line 109, and the included angle formed by the second straight line 109 and the first straight line 108 is greater than or equal to 100 degrees and less than or equal to 135 degrees. The base plate 111 includes a centerline 1113 passing through the center of the base plate 111, where the centerline 1113 is perpendicular to the direction of the first straight line 108 and the second straight line 109 relatively deviates from the centerline 1113 of the base plate 111 in a direction away from the first straight line 108. Typically, the user grips the cutting tool on one side of the saw blade, and with this configuration, the slurry can be caused to be discharged away from the user, thereby reducing the amount of water and slurry splashed on the user.

The included angle between the stop surface 1112 and the first plane 105 is greater than or equal to 10 degrees and less than or equal to 90 degrees. When the included angle between the stop surface 1112 and the first plane 105 is too small, the size of the base plate 111 is relatively increased, which is not conducive to the compactness of the whole cutting tool. When the included angle between the stop surface 1112 and the first plane 105 is too large, the probability that the slurry splashes over the mudguard to the rear of the mudguard is increased.

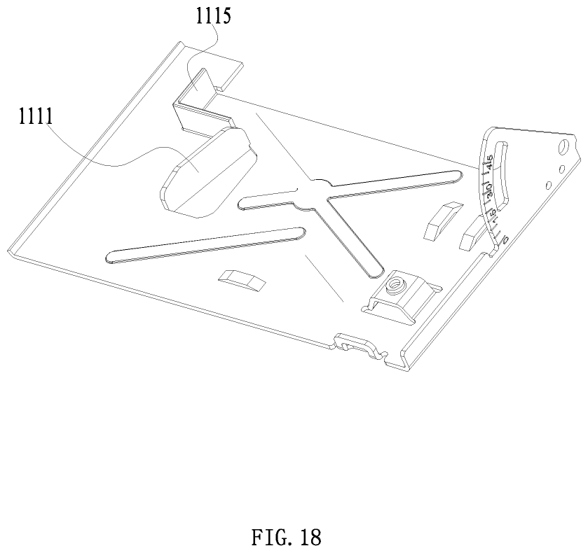

Referring to FIG. 18, an auxiliary mudguard 1115 is disposed at an end of the mudguard 1111 and configured to block slurry and water flows flying out from the end of the mudguard. The auxiliary mudguard 1115 may be disposed on either side or two sides of the end of the mudguard. For example, the auxiliary mudguard 1115 is disposed on the side close to the first straight line. The auxiliary mudguard 1115 may be L-shaped so as to completely block the slurry.

When the base plate 111 is at the first position, the height of the mudguard 1111 along the direction perpendicular to the first plane 105 is greater than or equal to 11 mm and less than or equal to 15 mm. Thus, the spacing between the base plate 111 and the housing is fully used, and a slurry-blocking effect can be improved.

Referring to FIG. 14, the projection of at least part of the stop surface along the direction perpendicular to the first plane toward the first plane forms an included angle α2 with the centerline, where the included angle α2 is greater than or equal to 10 degrees and less than or equal to 45 degrees.

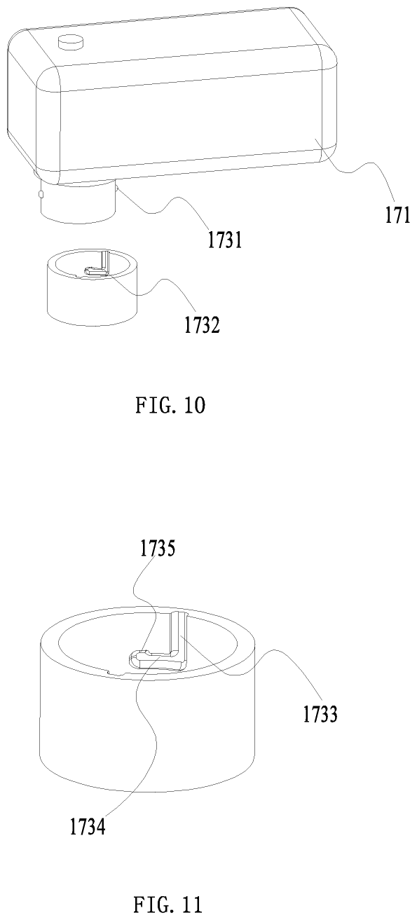

Referring to FIGS. 10 and 11, the cutting tool 100 includes a connection device 173, where the liquid storage device 171 is detachably connected to the housing 110 by the connection device 173. Part of the connection device 173 is disposed on the housing 110, and part of the connection device 173 is disposed on the liquid storage device 171. The connection device 173 includes a slider 1731 and a sliding slot 1732. The slider 1731 slides in the sliding slot 1732 to unlock and lock the liquid storage device 171 and the housing 110. The sliding slot 1732 includes a first sliding slot 1733, a second sliding slot 1734, and a locking slot 1735, where the first sliding slot 1733 and the second sliding slot 1734 are substantially perpendicular to each other, and the locking slot 1735 and the second sliding slot 1734 are disposed on the same side of the first sliding slot 1733. When mounting the liquid storage device 171, the user aligns the slider 1731 with the first sliding slot 1733, pushes the liquid storage device 171 toward the connection device 173, slides the slider 1731 in the first sliding slot 1733 to the bottom of the first sliding slot 1733, and rotates the water container 171 relatively to slide the slider 1731 in the second sliding slot 1734 to an end of the second sliding slot 1734 so as to place the slider 1731 in the locking slot 1735 so that the liquid storage device 171 is connected to the housing 110. For example, a spring is disposed at the end of the second sliding slot 1734 to keep the slider 1731 in the locking slot 1735.

For example, the connection device 173 adapts to urban water supply, that is, the connection device 173 can be connected to a tap water pipe. The user may connect, according to requirements, the liquid storage device 171 or the tap water pipe using the connection device 173.

For example, part of the guide 172 is configured to be in contact with the control chamber 161. For example, the guide 172 is configured to be in the shape of a “creeping line” and extend on a side surface of the control chamber 161, thereby increasing the contact area between the guide 172 and the control chamber 161 and dissipating the heat of the control board 160 with the cooling liquid.

The cutting tool 100 further includes a trigger 107 and a system control member 174. The trigger 107 controls the running of the electric motor 120, and the system control member 174 controls the flow of the cooling liquid in the guide 172.

The liquid storage system 170 further includes a linkage device connecting the trigger 107 to the system control member 174, and when the trigger 107 is pressed, the linkage device drives the system control member 174 to be opened. For example, the linkage device includes a linkage member and an elastic member 1741, and the elastic member is connected to the system control member 174. When the trigger 107 is not pressed, the elastic member 1741 keeps the system control member 174 closing the guide 172, and when the trigger 107 is pressed by the user, the linkage device drives the system control member 174 to be opened. Thus, it is convenient for the user to operate the cutting tool 100, and the cooling liquid in the liquid storage device 171 can be saved and the number of times the user needs to add the cooling liquid is reduced.

In an example, the system control member 174 is an electric water valve including an electromagnet, and the cutting tool 100 further includes a controller, where when the electric motor 120 runs, the controller controls the electromagnet to be displaced so that the water valve 174 is opened. For example, the controller is configured to: when the trigger 107 is pressed, open the water valve 174 and control, after N seconds, the electric motor 120 to be turned on so that the heat dissipation effect can be improved; when the trigger 107 is pressed, control the water valve 174 to be opened and the electric motor 120 to be turned on simultaneously; and when the trigger 107 is started, start the electric motor 120 and control, after N seconds, the water valve 174 to be opened so that the cooling liquid can be saved. For example, when the trigger 107 is released, the electric motor 120 is controlled to stop, and then the water valve 174 is controlled to stop.

For example, the liquid storage system 170 further includes a vibration sensor, and when the cutting tool 100 is operated, vibrates, and reaches a preset frequency, the water valve 174 is controlled by the controller to be opened so that the saw blade 131 and other elements are cooled and the dust and the slurry are removed.

When the electric water valve is used, a magnetic circuit is generated by electric power, which causes a relatively high temperature rise of the electromagnet. Therefore, the electric water valve is disposed in a heat dissipation air path provided in the present application, or the guide 172 is configured to be in contact with the electric water valve so that the cooling liquid in the guide 172 is used for dissipating the heat of the electric water valve.

For example, the cutting tool 100 further includes a water valve switch 175 connected to a control circuit of the water valve 174, and the control circuit of the water valve 174 is independent of a control circuit of the electric motor 120 so that the user can separately control, with the water valve switch 175, the water valve 174 to be opened or closed.

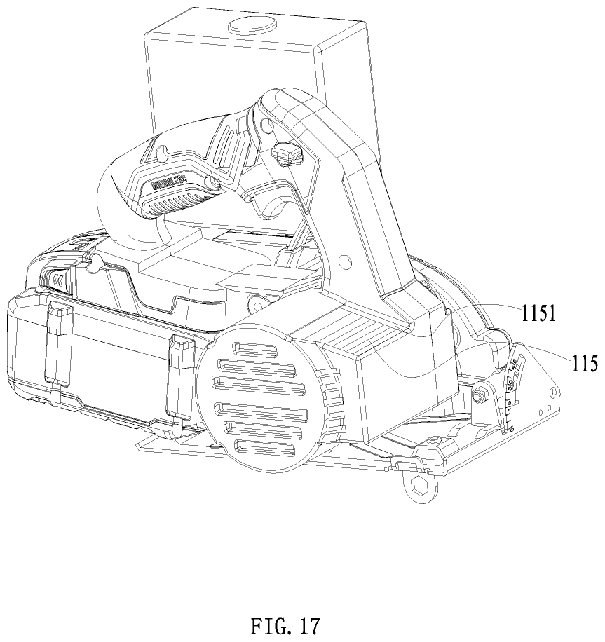

Referring to FIG. 17, a waterproof portion 115 is further disposed at the front end of the housing 110, where the waterproof portion 115 includes downwardly extending inclined slots 1151 configured to guide the water and slurry to be discharged from the upper end of the housing 110. For example, the housing 110 further includes a third air outlet 116, where the third air outlet 116 opens toward the battery pack 200, and part of the airflow generated in the housing 110 can flow to the battery pack 200 through the third air outlet 116 so that water and slurry on the surface of the battery pack 200 can be blown away.

In an example of the present application, air inlets are disposed near the control chamber where the control board is placed so that the airflow flows from the control chamber into the electric motor housing and flows out of the electric motor housing when the fan runs, and the electric motor housing is provided with no additional air inlet. Thus, the heat dissipation airflow dissipates the heat of the control board and then dissipates the heat of the electric motor so that the heat dissipation efficiency of the control board is ensured.

In an example, the trigger 107 in the cutting tool 100 is disposed at the front end of the grip 113 or disposed on the grip 113 so that when holding the tool, the user can more conveniently operate and control the tool to be turned on or off. In a specific implementation, when the user presses the trigger 107, the controller 10 can receive a turn-on signal outputted by the trigger 107 and controls the electric motor 120 to be turned on, and the cutting tool 100 starts and drives the saw blade 131 to rotate. In this example, the trigger 107 may be a press operation switch, a push switch, or a knob switch. The trigger 107 may generate different control signals according to different pressing forces, different control signals according to different push strokes, or different control signals according to different positions of a knob.

In this example, the trigger 107 can control the conduction state of the system control member 174. When the system control member 174 is turned on, the liquid flows in the guide 172, and when the system control member 174 is turned off, no liquid flows in the guide 172. That is to say, 120, the trigger 107 can control not only the running of the electric motor but also the flow of the liquid in the liquid storage device 171. In other words, the trigger 107 can control whether there is the liquid flowing in the guide 172 or not.

In an example, the system control member 174 is a solenoid valve including an electromagnet, where in the case of energization, the solenoid valve is opened and the liquid in the liquid storage device 171 flows out; and in the case of de-energization, the solenoid valve is closed and the liquid in the liquid storage device 171 cannot flow out. In a specific implementation, when the electric motor 120 runs, the controller 10 in the cutting tool 100 may control the electromagnet to be displaced so that the system control member 174 is opened. For example, the controller 10 is configured such that when the trigger 107 is pressed and operated, the system control member 174 is opened and after N seconds, the electric motor 120 is controlled to be turned on so that the heat dissipation effect can be improved. For example, when the trigger 107 is operated, the controller 10 controls the system control member 174 to be opened and the electric motor 120 to be turned on simultaneously. For example, when the trigger 107 is operated, the controller 10 starts the electric motor 120 and controls, after N seconds, the system control member 174 to be opened so that the cooling liquid can be saved. For example, when the trigger 107 is released and the operation ends, the controller 10 controls the electric motor 120 to stop and then controls the system control member 174 to stop.

In an example, to achieve different control states between the electric motor 120 and the system control member 174, the trigger 107 may have multiple different operation states, and different control signals may be outputted to the controller 10 in the different operation states. For example, the trigger 107 may have a certain switch stroke along a preset direction, and at least two control signals can be generated within a synchronous switch stroke. The preset direction refers to the direction in which the switch is operated when the machine is controlled to be turned on. In an implementation, different switch strokes of the trigger 107 correspond to the different operation states of the trigger 107, and the different control signals are generated in the different operation states. For example, when the trigger 107 is in a first operation state, a first control signal can be generated, and when the trigger 107 is in a second operation state, a second control signal can be generated. It is to be understood that the manner in which a switch stroke is generated is related to the type of the trigger 107. For example, the trigger 107 is a press switch, and when the switch is pressed with different forces, corresponding switch strokes are different, where the switch stroke is short when the force is small, and the switch stroke is long when the force is large. For example, the trigger 107 is the push switch, and as the user pushes the switch along a set turn-on direction, the switch stroke gradually increases. For example, the trigger 107 is the knob switch, and as the user rotates the knob along a set turn-on direction, the switch stroke gradually increases. For example, when the switch stroke of the trigger 107 is shorter than or equal to a first stroke threshold, the trigger 107 can generate the first control signal; and when the switch stroke of the trigger 107 is longer than the first stroke threshold, the trigger 107 can generate the second control signal.

In this example, the controller 10 can acquire a control signal outputted by the trigger 107, and when the first control signal is acquired, the controller 10 controls the system control member 174 to be opened so that the liquid storage system 170 is started. Thus, the liquid in the liquid storage device 171 enters the guide 172, flows through the guide 172, and then flows out from the guide ports 1721 to the saw blade 131 so as to wet the saw blade 131 so that the function of dissipating the heat of the grinding or wetting the workpiece can be fulfilled. When the controller 10 acquires the second control signal outputted by the trigger 107, the electric motor 120 can be started to rotate. It is to be understood that since a variation process of the switch stroke is less time-consuming, the system control member 174 can be started and then the electric motor 120 can be started in a short time. Based on the variation of the switch stroke, it is implemented that the system control member 174 and the electric motor 120 are not started simultaneously so that the objective to wet the workpiece and the saw blade in advance without wasting water can be achieved in a suitable time.

In an exemplary example, the switch stroke of the trigger 107 may be refined. For example, when the switch stroke of the trigger 107 is shorter than or equal to a second stroke threshold, the trigger 107 outputs no control signal, that is, the liquid storage device 171 is not opened in advance so that the waste of the liquid can be avoided when the switch stroke is relatively long. When the switch stroke is longer than a third stroke threshold and shorter than or equal to a fourth stroke threshold, a third control signal is outputted; and the controller 10 may control, based on the third control signal, the system control member 174 to be periodically opened, that is to say, the solenoid valve is controlled to be opened or closed cyclically. When the switch stroke is longer than a third stroke threshold, the trigger 107 outputs the first control signal, and the system control member 174 is controlled to be opened. It is to be understood that when the switch stroke is longer than a fourth stroke threshold, the trigger 107 may output the second control signal to control the electric motor 120 to start. The fourth stroke threshold is longer than the third stroke threshold. Different opening states of the system control member 174 are configured based on the preceding switch strokes. When the switch stroke is relatively short, the system control member 174 is not opened, when the switch stroke is slightly long, the system control member 174 is periodically opened, and when the switch stroke is long enough, the system control member 174 is directly opened. Thus, the system control member 174 can more flexibly adapt to a turn-on action of the trigger 107 with the different switch strokes.

It is to be noted that the first stroke threshold and the second to fourth stroke thresholds are set values in different examples and are related to a total switch stroke which the trigger 107 can have, and the first stroke threshold and the second to fourth stroke thresholds are not comparable. Therefore, the size of the first stroke threshold and the sizes of the second to fourth stroke thresholds are not limited.

In an example, in a working process of the cutting tool 100, the rotational speed of the electric motor 120 varies nonlinearly. That is to say, the electric motor 120 has different rotational speeds under different working conditions. For example, when the stone is relatively hard, the electric motor 120 has a relatively low rotational speed so that damage to the saw blade is avoided, and when the stone is relatively soft, the electric motor 120 may have a relatively high rotational speed so that efficiency is improved. However, under different working conditions, dust is generated or the saw blade generates heat at different levels. Therefore, the liquid storage system 170 may be more accurately controlled to meet requirements under the different working conditions.

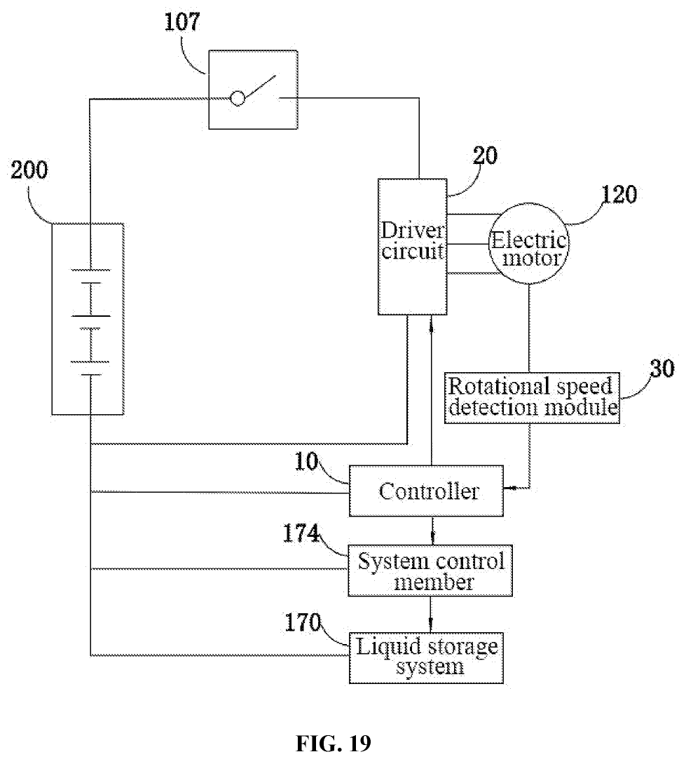

As shown in FIG. 19, the cutting tool 100 further includes a rotational speed detection module 30 capable of detecting the rotational speed of the electric motor 120. The controller 10 can acquire the rotational speed of the electric motor 120 outputted by the rotational speed detection module 30. In addition, when the rotational speed of the electric motor 120 is lower than a first rotational speed threshold, the system control member 174 is controlled to be closed; when the rotational speed is higher than or equal to the first rotational speed threshold and lower than or equal to a second rotational speed threshold, the system control member 174 is controlled to be periodically opened; and when the rotational speed is higher than the second rotational speed threshold, the system control member 174 is controlled to be opened. A liquid delivery system is controlled to discharge the liquid in different manners or discharge no liquid based on the different rotational speeds of the electric motor 120 so that the waste of the liquid is avoided and a better dustproof or cooling effect is achieved. It is to be understood that the controller 10 also controls the system control member 174 to output the liquid at a relatively low flow rate or a relatively low flow velocity when the rotational speed of the electric motor 120 is higher than or equal to the first rotational speed threshold. For example, when the rotational speed of the electric motor 120 is lower than 500 revolutions per minute, the controller 10 may control the system control member 174 to be closed; when the rotational speed of the electric motor 120 is from 500 to 3000 revolutions per minute, the controller 10 may control the system control member 174 to be opened periodically; and when the rotational speed of the electric motor 120 is higher than 3000 revolutions per minute, the system control member 174 is controlled to be opened. It is to be noted that the controller 10 may adjust, according to the actual rotational speed of the electric motor 120, a period in which the system control member 174 is periodically opened.

It is to be noted that a driver circuit 20 is further disposed between the electric motor 120 and the controller 10. The driver circuit 20 may transmit a current from the battery pack 200 to stator windings of the electric motor 120 to drive the electric motor 120 to rotate. In an example, the driver circuit 20 includes multiple switching elements, for example, six switching elements. A gate terminal of each switching element is electrically connected to the controller 10 and is configured to receive the control signal from the controller 10. A drain or a source of each switching element is connected to the stator windings of the electric motor 120. The six switching elements receive control signals from the controller 10 to change respective conduction states, thereby changing currents loaded on the stator windings of the electric motor 120 by the battery pack 200. In an example, the driver circuit 20 may be a three-phase bridge driver circuit including six controllable semiconductor power devices (such as field-effect transistors (FETs), bipolar junction transistors (BJTs), or insulated-gate bipolar transistors (IGBTs)). It is to be understood that the preceding switching elements may be any other types of solid-state switches such as the insulated-gate bipolar transistors (IGBTs) or the bipolar junction transistors (BJTs).

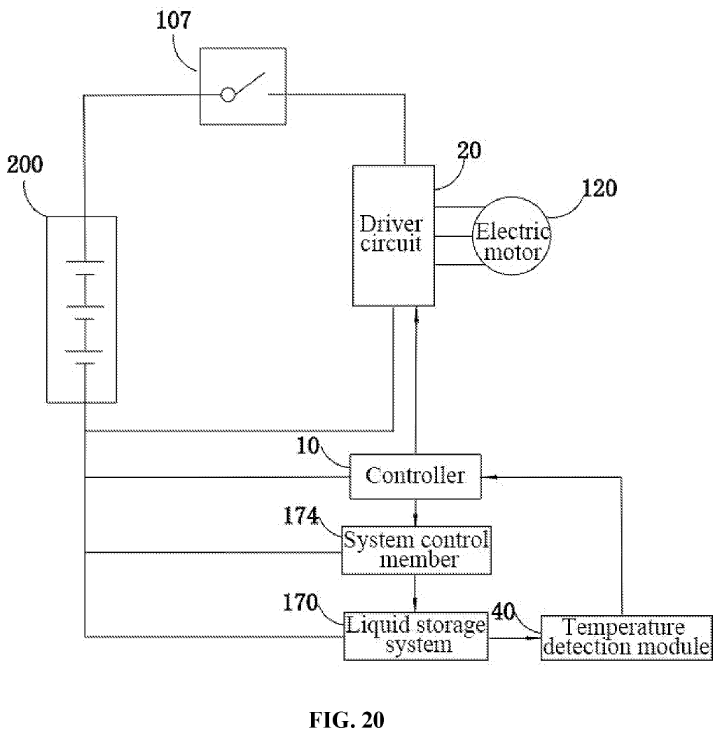

In an example, in the working process of the cutting tool 100, the temperature of the system control member 174 may also increase due to frequent energization or de-energization, thereby affecting the control accuracy of the system control member 174. To solve this problem, as shown in FIG. 20, the cutting tool 100 further includes a temperature detection module 40 configured to detect the temperature of the system control member 174 and output the temperature to the controller 10. When the temperature of the system control member 174 is higher than a first temperature threshold and lower than a second temperature threshold, the controller 10 controls the system control member 174 to be closed; and when the temperature of the system control member 174 is higher than or equal to the second temperature threshold, the controller 10 controls the electric motor 120 to stop rotating. For example, when the temperature of the system control member 174 is higher than 0° and lower than 60°, the electric motor 120 and the system control member 174 work normally; when the temperature of the system control member 174 is higher than 60° and lower than 90°, the system control member 174 has a relatively high temperature, the performance of the system control member 174 will be affected if the system control member 174 continues working, the controller 10 controls the system control member 174 to be closed, and in this case, the electric motor 120 can still work normally; and if the temperature of the system control member 174 continues increasing to be higher than or equal to 90°, the controller 10 controls the electric motor 120 to stop rotating, that is, in this case, the temperature of the system control member 174 also affects the normal work of the electric motor 120.

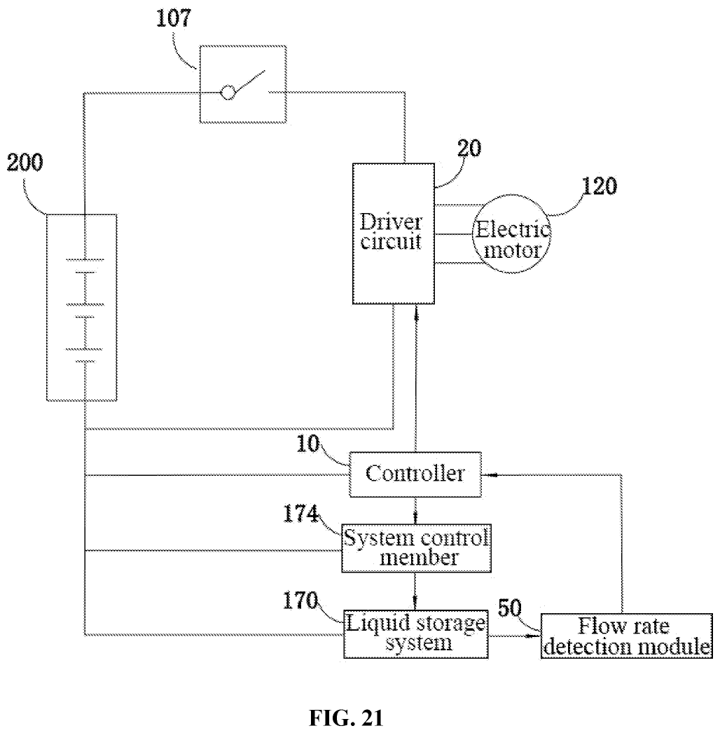

In an example, in the working process of the cutting tool 100, as the liquid is used, the volume of the liquid in the liquid storage device 171 decreases gradually, and if the discharge of the liquid is not stopped in time when the volume of the liquid is lower than a certain value, the liquid storage system 350 may be damaged. As shown in FIG. 21, the cutting tool 100 may also include a flow rate detection module 50 configured to detect the flow rate of the liquid in the liquid storage system 170 and transmit the detected flow rate to the controller 10, and when the flow rate is lower than a flow rate threshold, the controller 10 controls the system control member 174 to be closed. Thus, when there is less liquid in the liquid storage device 171, the liquid storage device 171 can be closed in advance so that damage to the liquid storage system 170 is avoided.

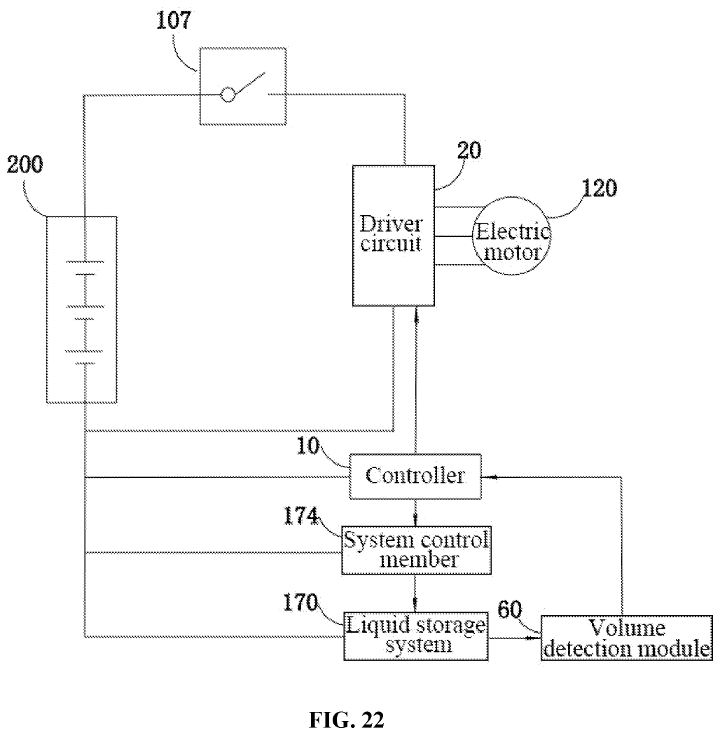

In an example, as shown in FIG. 22, a volume detection module 60 may also be disposed in the cutting tool 100 and is configured to detect the volume of the liquid in the liquid storage device 171 and transmit the volume to the controller 10. When the volume of the liquid is less than a volume threshold, the controller 10 may control the system control member 174 to be closed. Before the liquid in the liquid storage device 171 is insufficient to serve the function of cooling the tool or reducing the dust for the tool, the controller 10 can also close the system control member 174 in advance so that the damage to the liquid storage system 170 is avoided.

For example, after the liquid storage system 170 is controlled to stop discharging the liquid, the controller 10 may control the tool 100 to enter a standby state. After the liquid storage device 171 is filled with the liquid again, the tool 100 enters a working mode again, that is, the liquid is controlled to flow out and the electric motor 120 is started. For example, if the controller 10 detects, in a preset time period in which the system control member 174 is closed, that the volume in the liquid storage device 171 is not increased or the liquid flow rate is not increased after the liquid storage system 170 is turned on again, the controller 10 directly controls the electric motor 120 to stop.

In an example, if the controller 10 receives a fourth control signal, the controller 10 controls the electric motor 120 to stop rotating and controls, after the preset time period, the system control member 174 to be closed. It is to be understood that the trigger 107 may send out a fourth control signal when the switch stroke varies from maximum to zero. That is to say, the fourth control signal is a signal outputted by the trigger 107 when the user operates the tool and performs a normal turn-off operation. The fourth control signal is not a control signal for controlling the stop state of the electric motor 120 when the machine is stopped in an abnormal state. The so-called stop of the machine in the abnormal state may include the following cases: since no liquid is filled again during a period of time after the liquid in the liquid storage system 170 is insufficient and the system control member 174 is closed, the electric motor 120 is turned off; or since the system control member 174 has a relatively high temperature, the electric motor 120 is turned off. In this example, the system control member 174 is closed after the preset time period in which the user operates the tool and turns off the tool normally so that the saw blade can be quickly cooled after the machine is stopped and a better dust reduction effect can also be achieved.

In an example, when receiving the fourth control signal, the controller 10 may detect a current rotational speed of the electric motor 120 and match a suitable preset time period according to the rotational speed. For example, the higher the current rotational speed of the electric motor 120 when stopped, the longer the preset time period, and vice versa. In addition, when the electric motor 120 is turned off at a low rotational speed, the system control member 174 may be closed simultaneously.

In an example, at least one power element, such as a metal-oxide-semiconductor (MOS) transistor, is disposed between the system control member 174 and the controller 10, and the controller 10 controls the conduction state of the MOS transistor to control the system control member 174 to be opened or closed.

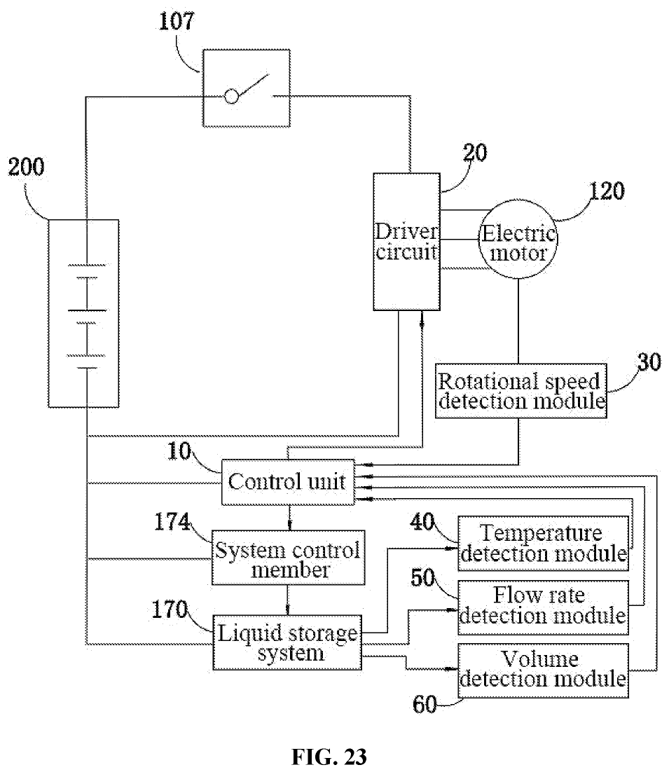

In an example, the control system of the cutting tool 100 may simultaneously include at least two of the rotational speed detection module 30, the volume detection module 60, the flow rate detection module 50, and the temperature detection module 40. As shown in FIG. 23, the control system of the cutting tool 100 may include all of the preceding detection modules.

In an example, the system control member 174 may not be controlled by the controller 10 to be opened or closed. Instead, when the trigger 107 is triggered, according to the triggered operation state of the trigger 107, the trigger 107 controls, through linkage, the system control member 174 to be opened, periodically opened, or closed. For example, when the trigger 107 is triggered to be in a first operation state, the system control member 174 can be triggered to be opened so that the liquid storage system 170 is started. When the trigger 107 is in a second operation state, the electric motor 120 can be triggered to rotate. It is to be noted that when the trigger 107 is in the second operation state, the second control signal may be generated in this state and transmitted to the controller 10, and the electric motor 120 is controlled by the controller 10 to be turned on. That is to say, the system control member 174 may be controlled by the trigger 107 through the linkage, and the electric motor 120 may be controlled by the controller 10. In an example, without being controlled by the controller 10, the electric motor 120 may be directly controlled by the trigger 107 to be started. For example, with the variation of the switch stroke of the trigger, the trigger 107 may control, through the linkage, the system control member 174 to be opened, periodically opened, or closed.

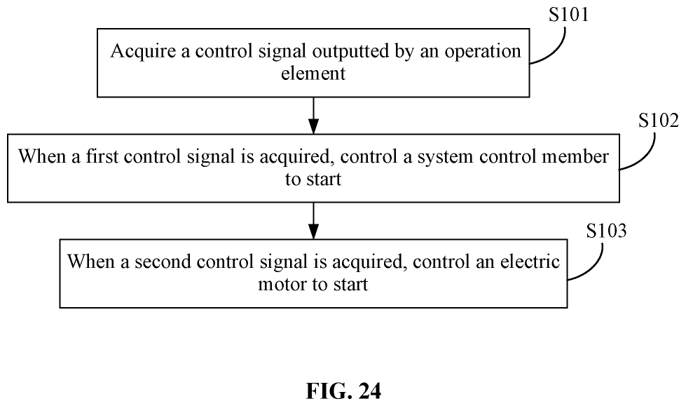

A method for controlling the electric motor and the system control member in the cutting tool 100 is described below with reference to FIG. 24. The method includes the steps described below.

In S101, a control signal outputted by an operation element is acquired.

It is to be understood that the operation element may output different control signals based on different switch strokes.

In S102, when the first control signal is acquired, the system control member is controlled to start.

In S103, when the second control signal is acquired, the electric motor is controlled to start.

The control method in the preceding example is also applicable to the control of a cutting tool 300 in the example described below.

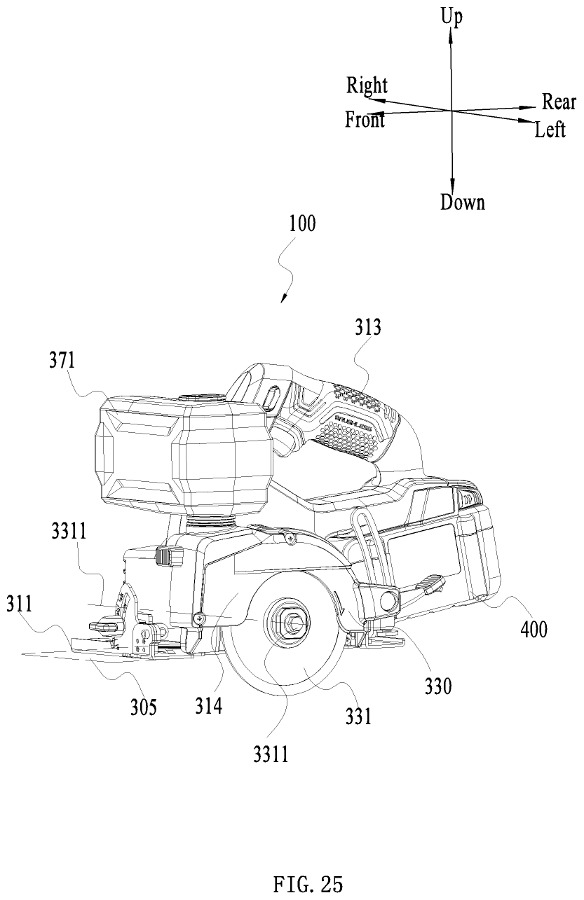

In an example, the cutting tool 300 is shown in FIG. 25. Structures and working principles of a housing 310, an electric motor 320, an accessory mounting portion 330, a transmission mechanism 340, an air inlet, an air outlet, and the like of the cutting tool 300 are similar to those in FIGS. 1 to 18 and are not described in detail here for the sake of simplicity. This example focuses on describing different structures and principles thereof from those in the cutting tool 100. For other structures which are not described, reference may be made to the description in the preceding example. In this example, regarding naming orders of different components and assemblies in the cutting tool 300, reference may also be made to naming orders in the preceding example.

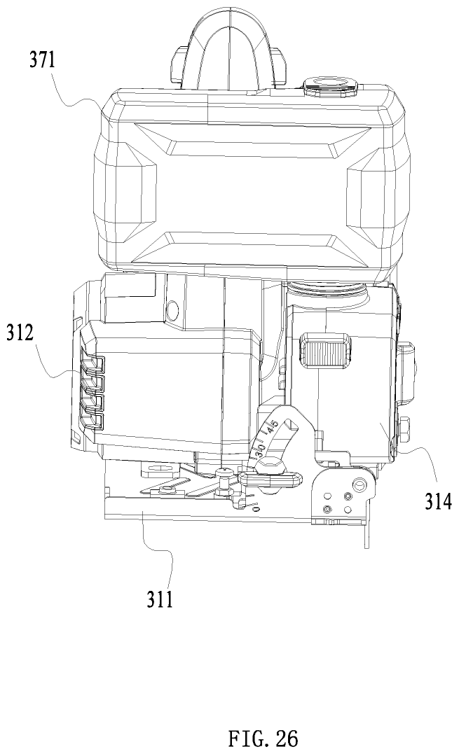

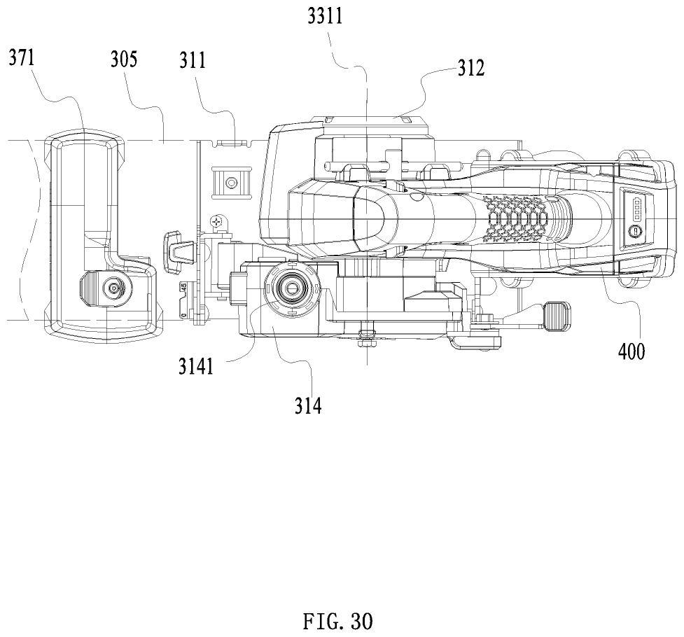

In an example, a liquid storage device 371 is mounted on the housing 310. As shown in FIGS. 25 to 28 and FIG. 30, the liquid storage device 371 is disposed on a shield 314 and located at the front end of the whole tool. The shield 314 is provided with a mounting interface 3141 for mounting the liquid storage device 371. In the direction of the first axis 3311, the length of an orthographic projection of the liquid storage device 371 on the first plane 305 is greater than or equal to the length of a base plate 311. In an implementation, as shown in FIG. 30, the orthographic projection of the liquid storage device 371 on the first plane 305 is approximately “L-shaped”.

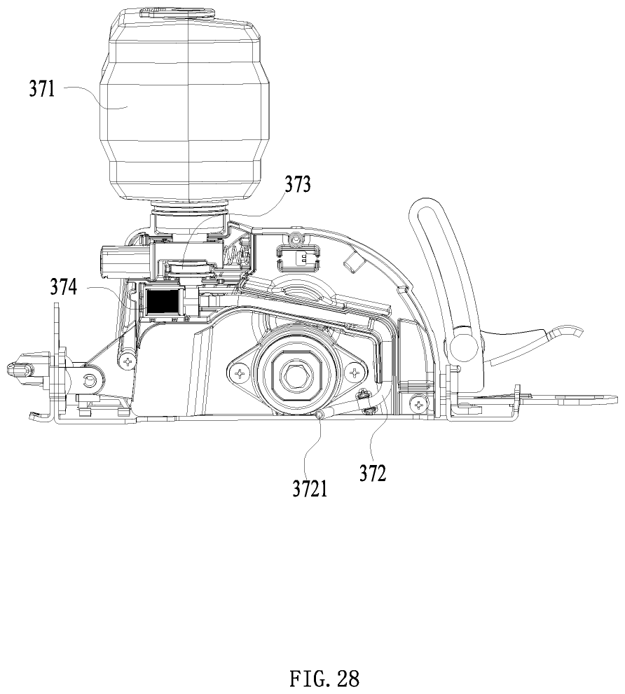

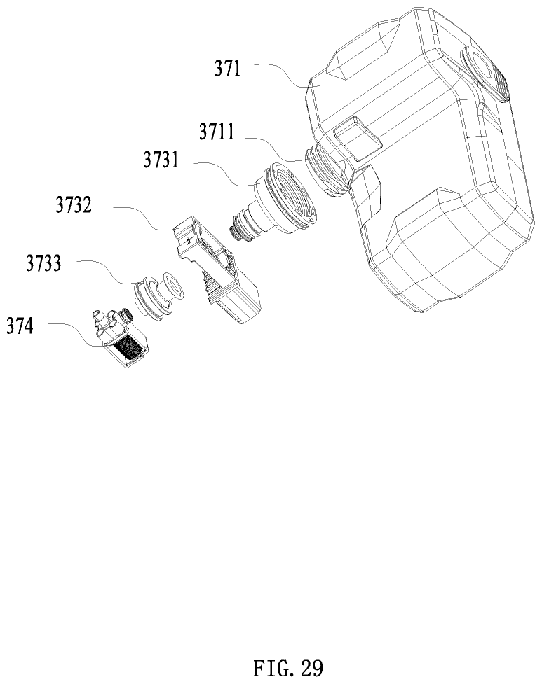

Referring to FIGS. 28 and 29, the cutting tool 300 further includes a connection device 373. The liquid storage device 371 is detachably connected to the housing 310 by the connection device 373. Part of the connection device 373 is disposed on the housing 310, and part of the connection device 373 is disposed on the liquid storage device 371. The connection device 373 includes a first connector 3731 in a threaded connection to an opening 3711 of the liquid storage device 371, an operation member 3732 for the user to control opening or closing, and a connector 3733 connected between the system control member 374 and the operation member 3732. In an implementation, the system control member 374 is a solenoid water valve.

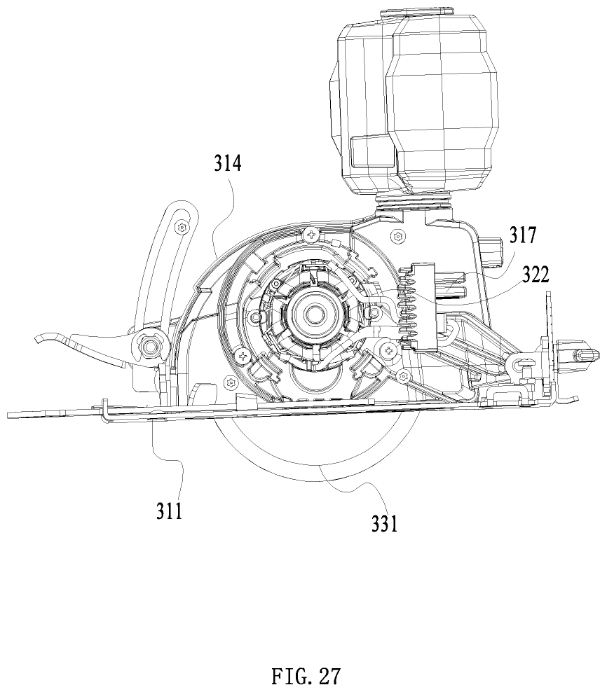

Referring to FIG. 27, the shield 314 is provided with a fourth air outlet 317. The cutting tool 300 further includes a second heat dissipation channel connecting an electric motor housing 321 to the fourth air outlet 317. The second heat dissipation channel can guide an airflow formed by the rotation of a fan into the shield 314 to dissipate the heat of the system control member 374. In an implementation, the electric motor housing 321 is formed with a housing opening 322, and the housing opening 322 and the fourth air outlet 317 are the inlet and outlet of the second heat dissipation channel is claimed is:

What is claimed is:

1. A cutting tool, comprising:
a housing;
an electric motor supported by the housing;
an accessory mounting portion comprising an output member configured to be connected to a saw blade;
a transmission mechanism connecting the electric motor to the output member;
a base plate disposed at a bottom of the housing and having a mounting hole for the saw blade to pass through;
a liquid storage system comprising a liquid storage device configured to store a liquid and detachably mounted on the housing; and
wherein the electric motor is a brushless motor, and a rotational speed of the electric motor is not lower than 7000 revolutions per minute when the cutting tool is in a working state.

2. The cutting tool according to claim 1, further comprising:
a power interface configured to be connected to a power supply;
wherein the housing forms an electric motor accommodation portion and a grip, the power interface is disposed at a rear end of the electric motor accommodation portion, and the accessory mounting portion is disposed at a side end of the electric motor accommodation portion.

3. The cutting tool according to claim 1, comprising a first air inlet and a first air outlet;
wherein the first air inlet is disposed at a rear end of the housing, the first air outlet is disposed at a front end of an electric motor accommodation portion, and part of an airflow is capable of entering the housing from the first air inlet and flowing through a battery pack interface.

4. The cutting tool according to claim 1, comprising a second air inlet and a second air outlet;
wherein the second air inlet is disposed at a battery pack interface, and the second air outlet is disposed at a lower end of an electric motor accommodation portion.

5. The cutting tool according to claim 1, wherein the base plate extends along a first plane, and an orthographic projection of a center of gravity of the cutting tool in the first plane is on the base plate when the liquid storage device is not mounted on the cutting tool.

6. The cutting tool according to claim 5, wherein the housing comprises a grip for a user to hold, when the liquid storage device is not mounted to the cutting tool, the orthographic projection of the center of gravity of the cutting tool on the first plane overlaps an orthographic projection of the grip on the first plane or overlaps an orthographic projection of the accessory mounting portion on the first plane, or the orthographic projection of the center of gravity of the cutting tool on the first plane is between the orthographic projection of the grip on the first plane and the orthographic projection of the accessory mounting portion on the first plane.

7. The cutting tool according to claim 1, wherein the base plate comprises a mudguard, and the mudguard protrudes upward relative to a first plane.

8. The cutting tool according to claim 7, wherein the cutting tool is capable of cutting along a direction of a first straight line, the base plate has a first position for causing the cutting tool to be at a maximum cutting depth, a side surface of the mudguard forms a stop surface, a projection of at least part of the stop surface on the first plane along a direction perpendicular to the first plane forms an included angle with the first straight line, and the included angle is greater than or equal to 100 degrees and less than or equal to 160 degrees.

9. The cutting tool according to claim 8, wherein, when the base plate is at the first position, a height of the mudguard along the direction perpendicular to the first plane is greater than or equal to 10 mm and less than or equal to 20 mm.

10. The cutting tool according to claim 8, wherein, when the base plate is at the first position, a distance from the first plane to a lowest point of the saw blade is greater than or equal to 20 mm and less than or equal to 35 mm.

11. The cutting tool according to claim 2, wherein the power supply is a battery pack, and a rated voltage of the battery pack is higher than or equal to 10 V and lower than or equal to 26 V.

12. The cutting tool according to claim 2, wherein the housing further comprises a shield disposed on a peripheral side of the saw blade, the base plate extends along a first plane, in a direction perpendicular to the first plane, a top of the shield is close to the base plate relative to a top of the grip, and a height difference between the top of the grip and the top of the shield in the direction perpendicular to the first plane is greater than or equal to 100 mm.

13. The cutting tool according to claim 12, wherein the liquid storage device is at least partially located on the shield.

14. A cutting tool, comprising:
a housing;
an electric motor supported by the housing;
an accessory mounting portion comprising an output member configured to be connected to a saw blade;
a transmission mechanism connecting the electric motor to the output member;
a base plate disposed at a bottom of the housing and having a mounting hole for the saw blade to pass through;
a power interface configured to be detachably connected to a power supply device; and
a liquid storage system comprising a liquid storage device configured to store a liquid and detachably mounted on the housing;
wherein the electric motor is a brushless motor.

15. A cutting tool, comprising:
a housing;
an electric motor supported by the housing;
an accessory mounting portion comprising an output member configured to be connected to a saw blade;
a transmission mechanism connecting the electric motor to the output member;
a base plate disposed at a bottom of the housing and having a mounting hole for the saw blade to pass through;
a liquid storage system comprising a liquid storage device configured to store a liquid and detachably mounted on the housing; and
a system control member disposed on a liquid flow path of the liquid storage system and used for controlling a flow state of the liquid in the liquid storage device.

16. The cutting tool according to claim 15, wherein the housing forms an electric motor accommodation portion and a grip, a battery pack interface is disposed at a rear end of the electric motor accommodation portion, and the accessory mounting portion is disposed at a side end of the electric motor accommodation portion.

17. The cutting tool according to claim 15, further comprising a control board disposed at a front end of an electric motor accommodation portion.

18. The cutting tool according to claim 15, wherein the liquid storage device is at least partially disposed above the accessory mounting portion.

19. The cutting tool according to claim 15, wherein the output member is rotatable about a first axis and, when the liquid storage device is mounted on the housing, a projection of the liquid storage device along the first axis is within a projection of an outer contour of the housing.

20. The cutting tool according to claim 19, wherein the base plate extends along a first plane, and in a direction perpendicular to the first plane, a top of the liquid storage device is close to the base plate relative to a top of a grip.
